(19) United States
(12) Patent Application Publication
(10) Pub. No.: US 2022/0383361 A1
(43) Pub. Date: Dec. 1, 2022

(54) METHOD AND APPARATUS FOR PROVIDING A PRIVACY-PRESERVING YET TARGETED DELIVERY OF LOCATION-BASED CONTENT

(71) Applicant: HERE Global B.V., Eidhoven (NL)

(72) Inventor: Stefano BENNATI, Zurich (CH)

(21) Appl. No.: 17/331,286

(22) Filed: May 26, 2021

(51) Int. Cl. G06Q 30/02; H04L 9/30; H04W 12/64; H04W 12/02; H04W 12/033

(52) U.S. Cl. CPC G06Q 30/0261; H04L 9/30; H04W 12/64; H04W 12/02; H04W 12/033; G06Q 30/0207; G06Q 2220/12

(57) ABSTRACT

An approach is provided for providing a privacy-preserving yet targeted delivery of location-based content. The approach involves, for example, initiating a first transmission of content consumer public key(s) associated with content consumer(s) to a content provider. The approach also involves, in response to the transmission, receiving encrypted content encrypted with the content consumer public key(s). The encrypted content is cryptographically signed with a content provider private key associated with the content provider. The approach further involves initiating a second transmission of the encrypted content to a consumer device. A content provider public key for decrypting the encrypted content is made available based on (1) the consumer device scanning the content provider public key at a location designated by the content provider, or (2) detecting that the consumer device is located within a threshold proximity of the location.

### BACKGROUND

Recent advances in smart phones and location-based information services have led to location-based content delivery to specific groups of users in real-world environments, e.g., museums, offices, shops, restaurants, and/or other points of interest. At the same time, within an increasingly connected communications environment, the users are increasingly concerned with the privacy of their data. However, delivering such location-based content (e.g., advertisements) to target recipients (e.g., consumers) based on user profiles and locations requires content delivery agencies/platforms to track the user locations to measure success rates of the content delivery, thereby revealing user location data as well as data of user interactions with point of interest operators (e.g., museums, offices, shops, etc.). There are ways, such as public key cryptography, to facilitate users to share private data on the existing networks while maintaining user privacy. However, the encryption techniques rely upon keys that are typically mapped to user identities and expose consumer private data to the content delivery agencies/platforms. Consequently, device manufacturers and service providers face significant technical challenges to distribute location-based content to target recipients without revealing the identities of the target recipients to the point of interest operators and the content delivery agencies/platforms.

### SOME EXAMPLE EMBODIMENTS

Therefore, there is a need for an approach for providing a privacy-preserving yet targeted delivery of location-based content.

According to one embodiment, a method comprises initiating a first transmission of at least one content consumer public key associated with at least one content consumer to a content provider. The method also comprises, in response to the transmission, receiving encrypted content encrypted with the at least one content consumer public key. The encrypted content is cryptographically signed with a content provider private key associated with the content provider. The method further comprises initiating a second transmission of the encrypted content to a consumer device. A content provider public key for decrypting the encrypted content is made available based on (1) the consumer device scanning the content provider public key at a location designated by the content provider, or (2) detecting that the consumer device is located within a threshold proximity of the location designated by the content provider.

According to another embodiment, an apparatus comprises at least one processor, and at least one memory including computer program code for one or more computer programs, the at least one memory and the computer program code configured to, with the at least one processor, cause, at least in part, the apparatus to transmit a request to initiate a content delivery campaign for delivering content from a content provider to at least one content consumer. The request specifies a target profile for selecting the at least one content consumer. The apparatus is also caused to receive, in response to the request, at least one content consumer public key associated with at least one content consumer that is selected based on the target profile. The apparatus is further caused to encrypt the content using the at least one content consumer public key. The apparatus is further caused to initiate a transmission of the encrypted content to a content delivery platform. The content delivery platform transmits the encrypted content to at least one consumer device associated with the at least one content consumer. The consumer device decrypts the encrypted content using a content provider public key scanned at a location designated by the content provider or provided based on the consumer device being within a threshold proximity to the location.

According to another embodiment, a computer-readable storage medium carries one or more sequences of one or more instructions which, when executed by one or more processors, cause, at least in part, an apparatus to receive from a content delivery platform encrypted content. The encrypted content is associated with a content provider public key associated with a content provider. The apparatus is also caused to scan the content provider public key provided at a location designated by the content provider or receive the content provider public key based on a threshold proximity to the location. The apparatus is further caused to decrypt the encrypted content using the scanned content provider public key to verify the encrypted content. The apparatus is further caused to present the decrypted content, the encrypted content, or a combination thereof directly to the content provider based on the verifying.

According to another embodiment, an apparatus comprises means for transmitting a request to initiate a content delivery campaign for delivering content from a content provider to at least one content consumer. The request specifies a target profile for selecting the at least one content consumer. The apparatus also comprises means for receiving, in response to the request, at least one content consumer public key associated with at least one content consumer that is selected based on the target profile. The apparatus further comprises means for encrypting the content using the at least one content consumer public key. The apparatus further comprises means for initiating a transmission of the encrypted content to a content delivery platform. The content delivery platform transmits the encrypted content to at least one consumer device associated with the at least one content consumer. The consumer device decrypts the encrypted content using a content provider public key scanned at a location designated by the content provider or provided based on the consumer device being within a threshold proximity to the location.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a privacy-preserving yet targeted delivery of location-based content, according to one embodiment;

FIGS. 2A-2B are ladder diagrams that illustrate a sequence of a location-based targeted content delivery process, according to one embodiment;

FIG. 3 is a diagram of the components of a content delivery platform module, according to one embodiment;

FIG. 4 is a flowchart of a process for providing a privacy-preserving yet targeted delivery of location-based content, according to one embodiment;

FIG. 5 is a flowchart of a process for classifying in-game behavior to generate privacy policies, according to one embodiment;

FIG. 6 is a flowchart of a process for determining sensitivity status information for locations based on in-game behavior data, according to one embodiment;

FIGS. 7A-7B are diagrams of example user interfaces depicting processes for providing a privacy-preserving yet targeted delivery of location-based content, according to various example embodiments;

FIG. 8 is a diagram of a geographic database, according to example embodiment(s);

FIG. 9 is a diagram of hardware that can be used to implement example embodiment(s);

FIG. 10 is a diagram of a chip set that can be used to implement example embodiment(s); and

FIG. 11 is a diagram of a mobile terminal (e.g., handset or part thereof) that can be used to implement example embodiment(s).

### DESCRIPTION OF SOME EMBODIMENTS

Examples of a method, apparatus, and computer program for providing a privacy-preserving yet targeted delivery of location-based content are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the various embodiments discussed herein refer to generating privacy policies, it is contemplated that the approaches presented in the embodiments are also applicable to any type of policy (e.g., security policy, access policies, etc.) that can be applied to a user device. Moreover, although the policies described herein are discussed as location-based policies (e.g., polices associated with specific locations such as in-game and/or real-world locations), it is contemplated that the approaches presented in the embodiments are also applicable to policies based on other contextual parameters (e.g., by contact, by activity, by time, etc.).

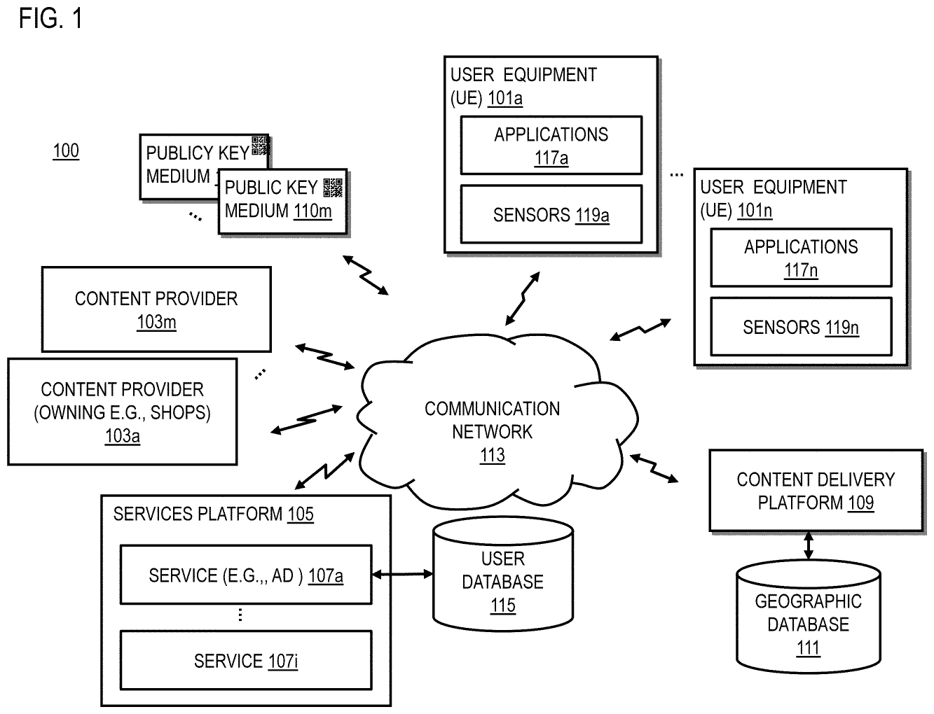

FIG. 1 is a diagram of a system capable of providing a privacy-preserving yet targeted delivery of location-based content, according to one embodiment. The popular advertisement platforms, such as Google, Facebook, etc., track user browsing content and online transactions to compute conversion rates (e.g., using cryptographic cookies). On the other hand, geo-located advertisement campaigns require tracking of consumer locations, in order to measure the successful conversion of the campaigns into offline purchases.

As mentioned, delivering location-based content (e.g., advertisements) to target recipients (e.g., consumers) based on user profiles and locations requires content delivery agencies/platforms to track the user locations to measure success rates of the content delivery, thereby revealing user location data as well as data of user interactions with point of interest operators (e.g., museums, offices, shops, etc.). By way of example, some content delivery agencies use a geo-fence of a predefined geographical area, where the consumer device monitors consumer locations and activates a pre-downloaded advertisement campaign as soon as the consumer enters the predefined geographical area. Such approach requires constant monitoring of the consumer locations, and exposes the contents (e.g., advertisements) and results of the campaign (e.g., conversion rates) to content delivery platforms.

There are ways to facilitate users to encrypt and share private data on the existing networks while maintaining data privacy. However, the encryption techniques rely upon keys that are typically mapped to user identities and expose consumer private data to the content delivery agencies/platforms.

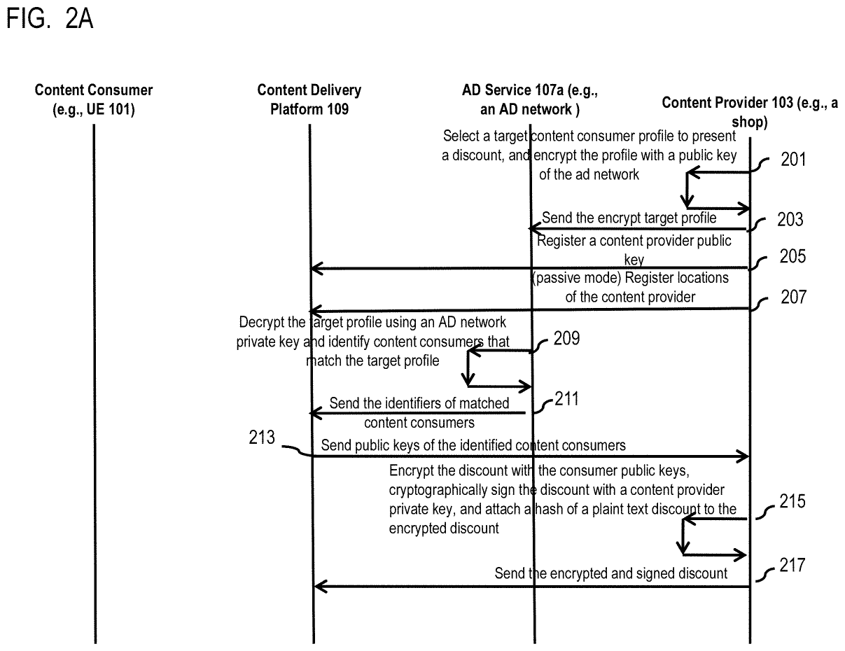

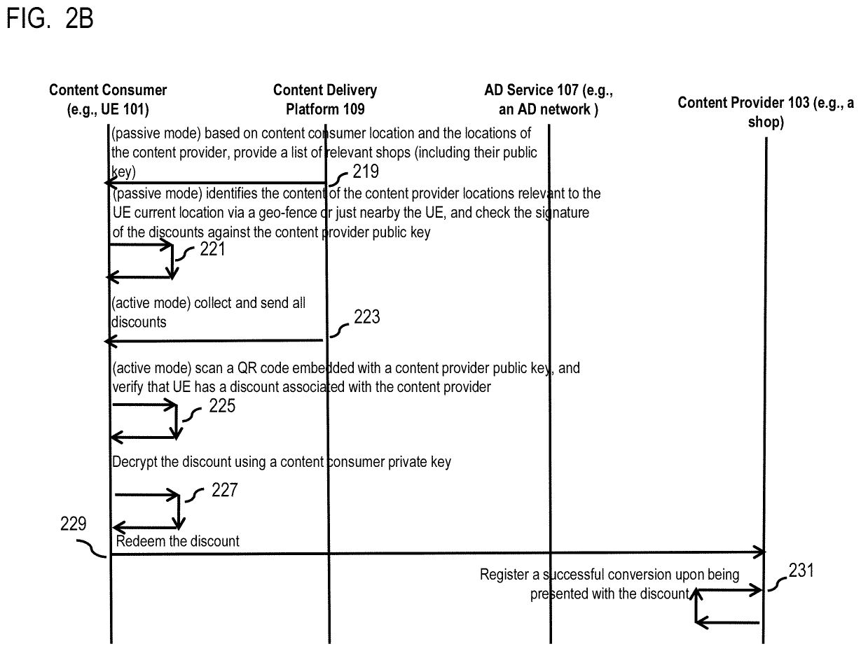

To address this problem, a system 100 of FIG. 1 introduces a capability of enhancing location-based targeted content delivery with a cryptographic management layer that keep certain information secret to other participants in the location-based targeted content delivery process without monitoring location(s) of content consumer(s). In one embodiment, the system 100 can operate an active mode. For instance, the system 100 can present the location-based content (e.g., advertisements, discounts, etc.) of one or more content providers 103a-103m (collectively referred to as content providers 103) to target consumer(s) carrying one or more user equipment (UE) 101a-101n (also collectively referenced to herein as UEs 101) without tracking the UE locations by offering the consumer(s) a location-based targeted content application (e.g., a discount-wallet application) which contains a list of content delivery campaigns relevant for the consumer(s) based on, for example, a target profile. As such, the system 100 can thus deliver the location-based targeted content anonymously to UEs 101 without disclosing the consumer and/or UE identities to the content providers 103, as well as keeping other information secret from other participants such as a services platform 105, one or more services 107a-107i (collectively referred to as services 107, including an advertisement service 107a), a content deliver platform 109, etc. as later described in conjunction with FIGS. 2A-2B. Whenever the consumer(s) reaches a location of a participating content provider 103 (e.g., a shop), the consumer(s) and/or the UE 101 can retrieve a corresponding discount (if any is present in the list) by detecting one or more content provider public keys embodied in tangible or intangible media 110a-110m (collectively referred to as public key media 110 associated with one or more of the content providers 103).

In public key cryptography, the key distribution of public keys is done through public key servers. When a user creates a key-pair, the user keeps one private key and the public-key is uploaded to a server where it can be accessed by anyone to send the user an encrypted message. In the active mode, to ensure that the UE 101 is physically present at a location designated by the content provider 103, the system 100 can invite the consumer(s) and/or activate the UE 101 to scan one or more content provider public key media 110 in the shop.

For instance, a content provider public key can be embodied as a QR code, a near-field communication (NFC) tag, a Bluetooth beacon, a Wi-Fi signal, etc. that is presented in the shop. In this case, the QR code is embedded with a content provider public key and/or a link (e.g., URL) to the content provider public key, rather than a content provider payment ID, a product ID, etc. that are commonly shown in retail stores. By way of example, when any shopper (rather than a target content consumer) scans a QR code for a virtual reality (VR) headset, the shopper can directly receive a promotion (e.g., a free game) if the shopper buys the VR headset in the store. On the other hand, according to the active mode of the system 100, a target content consumer (e.g., a VR Master League associates, participants, fans, etc.) and/or UE 101 scans a content provider public key QR code, to verify that the UE 101 has stored with a promotion associated with the content provider 103 and/or the shop associated with the content provider 103. After the verification, only the UE 101 of the target content consumer can decrypt the promotion using the respective content consumer private key, then redeem the promotion at the shop.

Such content consumer privacy can be either a shared private key among content consumers, or individual private keys for each content consumer that share a single content consumer public key. A content consumer public key can be an individual content consumer public key or a group content consumer public key (of all content consumers of the system 100, or a subgroup of the content consumers of the system 100) associated with the target profile. As such, the active mode allows the content provider 103 to control what kind of consumers to receive the promotion without knowing the consumer identities, rather than providing the promotion to any shoppers.

In another embodiment, the system 100 can operate a passive mode. For instance, the system 100 can monitor imprecise/coarse locations of the UE 101 to select relevant location-based targeted content (e.g., discount(s)) and display the content before or when the UE 101 reaches the shop, without user interaction (e.g., no scanning of a QR code).

FIGS. 2A-2B are ladder diagrams that illustrate a sequence of a location-based targeted content delivery process, according to one embodiment. In one embodiment, the UE 101, the content providers 103, the services platform 105, the services 107, the content deliver platform 109, the public key media 110, and other components of the system 100 have connectivity to each other via a communication network 113. A step or information transmitted from one actors/participants to another is represented by a horizontal arrow (e.g., a peer-to-peer (P2P) message, e-mail, text messaging, etc.), while internal processing can be represented as a loop box back to an actor/participant.

For instance, working via the location-based targeted content delivery process, the content provider 103 can deliver location-based targeted content (e.g., discount(s)) to content consumers with target characteristics that come near a location associated with the content provider 103 (e.g., a shop), and determine a number of delivered/presented targeted content items (e.g., redeemed discounts) to compute a conversion rate. The AD service 107a can shop user profiles associated with content consumer characteristics (e.g., in a user database 115), and assign the location-based targeted content (e.g., discount(s)) to relevant content consumers. A user profile includes personal data associated with a specific user, such as identity, username, passwords, age, height, weight, jobs, address, educations, hobbies, income, family, contacts, relationships, exercises, gym memberships, TV shows, podcasts, magazines, blogs, social media, online shops, purchasing habits, goals, motivations, challenges, pain points, etc.

The content deliver platform 109 can orchestrate the location-based targeted content delivery, for example, via a location-based targeted content application in the UE 101 that shows the location-based targeted content (e.g., discount(s)) to the target content consumer. The target content consumer carrying the UE 101 can view the discount(s) when near or at the shop, and keep UE locations private from the AD service 107a.

In one embodiment depicted in FIG. 2A, the content provider 103 can start a location-based targeted content campaign (e.g., a discount) by selecting a target content consumer profile to present the discount, and encrypting the target content consumer profile with a public key of the AD service 107a (Step 201). In the instance shown, the content provider 103 can then send the encrypted target profile to the content deliver platform 109 (Step 203). In addition, the content provider 103 can register a content provider public key with the content deliver platform 109 (Step 205). Referring back to the passive mode, the content provider 103 can register all of its locations (e.g., shops) with the content deliver platform 109 (Step 207).

In one embodiment, the AD service 107a can assign a user identifier and user profile tags (e.g., age, job, height, weight, etc.) to a content consumer, then store the user profile data in a user database 115. Optionally, the user identifier can be an anonymous ID. The AD service 107a can decrypt the encrypted target profile using its private key and identify content consumers that match the target profile (Step 209) based on the user profile data stored in the user database 115. The AD service 107a can then send the identifiers of matched content consumers with the identity of the content provider 103 to the content deliver platform 109 (Step 211).

In one embodiment, the content deliver platform 109 stores or has access to public keys of content consumers that subscribe to the system 100. After receiving the identity of the content provider 103 and the identifiers of the matched content consumers, the content deliver platform 109 can send public keys of the identified content consumers to the content provider 103 (Step 213). In this case, the content deliver platform 109 only knows the identifiers of the target content consumers, but neither the target profile for the discount nor the user profiles of the target content consumers.

The content provider 103 can then encrypt the discount with the public keys of the identified content consumers, cryptographically sign the discount with a content provider private key (e.g., hashing of the plain text of the discount using e.g., SHA-256, SHA-512, etc.), and attach the hash to the encrypted discount (Step 215). Since the discount is encrypted with the public keys of the identified content consumers, only the identified content consumers can use their private keys to decrypt and read the encrypted discount. This ensures that the discount will be read only by consumers matching the target profile. Since the discount is signed with the content provider private key, only the consumers located within a geo-fence or near a store of the content provider 103 can access a respective content provider public key and check the content provider signature with the content provider public key. This ensures that the signed discount will be accessed only by consumers located within the geo-fence or near the store. The content provider 103 can then send the encrypted and signed discount to the content deliver platform 109 (Step 217).

Continuing the process in FIG. 2B, in the passive mode, the content deliver platform 109 can pre-cache encrypted discounts. The content deliver platform 109 can provide a list of relevant shops with corresponding content provider public key(s) with encrypted discounts to the UE 101, based on a content consumer location and the locations of the shops (Step 219). For instance, one location can host only product(s)/service(s) of the content provider 103 (e.g., an Apple shop). As another instance, one location (e.g., a supermarket) can host product(s)/service(s) of a plurality of content providers 103 (e.g., various food and household suppliers).

In the passive mode, the UE 101 can identify the content (e.g., encrypted discounts) of the content provider locations relevant to the UE current location, for example, via a geo-fence or just nearby the UE 101, and check the signature on the discount against the respective content provider public key(s) cached in the UE 101 (Step 221).

In the active mode, the content deliver platform 109 can collect and send all encrypted discounts offered by the content providers 103 within an area of interest to the UE 101 (Step 223). For example, the area of interest can be set by the system 100 and/or the UE 101 based on a user profile associated with the UE 101. Since the discounts are encrypted, the content deliver platform 109 does not know the content of the discounts.

When the content consumer and/or the UE 101 subsequently scans a QR code embedded with a content provider public key at the shop, the UE 101 can verify that the UE 101 has stored a discount associated with the content provider among all discounts stored therein (Step 225). Alternatively, the content deliver platform 109 can retrieve from a cloud all encrypted discounts offered by the content providers 103 within the area of interest and then send all of the encrypted discounts to the UE 101, when the UE 101 scans a QR code.

Thereafter, the UE 101 can decrypt the encrypted discount using a content consumer private key (Step 227), and redeem the discount at the shop (Step 229) e.g., via a point of sale device. The shop and/or the content provider 103 can register a successful conversion upon being presented with the discount (Step 231). In addition, the shop and/or the content provider 103 can record any UE actions and/or UE interactions with the point of sale device or the like, such as UE accessing various device functions including but not limited to accessing one or more sensors (e.g., a camera sensor, a location sensor, a microphone, etc.), sharing location information at the shop, device pairing at the shop, etc.

After the location-based targeted content delivery process, the actors/participants know enough information to carry their respective functions without knowing certain private information of the content consumers and/or the content providers 103. For instance, the content provider 103 knows the discount, the target content consumer profile for the campaign, e.g., which kinds of consumers they want to show the discount to, a number of content consumers targeted by the campaign, and the conversion rate. On the other hand, the content providers 103 does not know the identities of the target content consumers, or the locations of the target content consumers (except knowing when a content consumer redeems a discount at a shop).

The AD service 107a stores user profiles including content consumer profiles, yet has no information about the locations of the target content consumers, the contents of the campaign (e.g., the discount), or the conversion rate. The content deliver platform 109 (e.g., Google, Facebook, etc.) knows which content provider(s) 103 started which campaign(s), and the identifiers of content consumers targeted by the campaign in both the active mode and the passive mode. However, The content deliver platform 109 does not know the contents of the campaign (e.g., the discount), or the conversion rate. Additionally, in the passive mode, the content deliver platform 109 knows coarse locations of UEs/content consumers (but not the exact locations of the UEs/content consumers) and the locations of stops of the content providers 103.

Beside the AD service 107a, the services 107 can include mapping services, navigation services, transportation services, social media services, and/or other data services that can provide location-based targeted content. By way of example, the services 107 may deliver transport schedule data (e.g., train/subway schedules, elevator schedules, etc.), weather data, and/or other data targeted for passenger(s) in stops of the train/subway schedules and requiring elevator(s) in the stops (e.g., handclapped, with heavy load(s), etc.). As another example, the services 107 may deliver ride-sharing information at airport terminals, train stations, etc. for target passenger(s) with destinations (e.g., home, office, etc.) en route of one or more shared vehicles.

As yet another example, the services 107 can include geospatial vaccination data services that provide navigation and location recommendation associated with POIs (e.g., malls, supermarkets, hotels, restaurants, museums, stadiums, offices, buildings, shops, parks, schools, etc.) to target content consumers (e.g., COVID-19 vaccinated people) based on geospatial vaccination data. For example, the system 100 can recommend targeted content consumers to wait in certain areas of department shop lobbies, airport terminals, etc. with minimal or no unvaccinated people to minimize COVID-19 exposure.

Therefore, the system 100 can minimize data exposures to the actors/participants, i.e., only required information shared between actors/participants. In the active mode, the system 100 can work without obtaining location data from the UE 101 at all, but by manual scanning of QR codes. When the content consumers are not particularly concerned about revealing their imprecise/coarse locations (in the passive mode), the system 100 can display discounts whenever the UE 101 nearby a store, without manually scanning the QR code(s). A course location can be a level of location that is less than what can be sensed by a device, i.e., reduced from the maximum location precision that is available. For instance, such imprecise/coarse locations of UE 101 can be retrieved from communication network providers that can determine the locations of the UEs 101 using cell towers, Wi-Fi access points, etc. which may not be as precise as GNSS-based location estimates, thereby preserving a higher degree of privacy for the content consumer.

In one embodiment, the coarse location of the UE 101 can be expressed as an area covered by a cell tower, Wi-Fi access point, etc. By way of example, a 3G/4G/5G mobile base station tower can reach up to 50 km-150 km, such that a coarse location of the UE 101 can be expressed as a circle of 50 km radius from the connected based station. As another example, a 5G (millimeter waves) mobile base station can reach 250-300 meters, such that a coarse location of the UE 101 can be expressed as a circle of 250 meters radius from the connected based station.

In another embodiment, the roles/functions of the AD service 107a and the content deliver platform 109 can be taken by the same entity. Accordingly, the location of the content consumer(s) in the passive mode might be disclosed to the AD service 107a.

In yet another embodiment, the roles/functions of the AD service 107a and the content provider 103 can be taken by the same entity. Accordingly, the profile data of the content consumer(s) might be disclosed to the content provider 103.

In one embodiment, the system 100 can set up a communication channel between the content consumer and the shop and/or the content provider 103 using blockchain technologies, such as implementations of electronic IDs on the blockchain. For instance, a content consumer can store an anonymous identity (i.e., not containing the actual name of the content consumer but just sufficient details (e.g., as included in a target profile) to set up the communication channel) on the blockchain to be validated by a trusted party (e.g., a government, the AD service 107a, the content deliver platform 109, etc.), and then uses the identity to authenticate with the services (e.g., the content provider 103) to receive promotions.

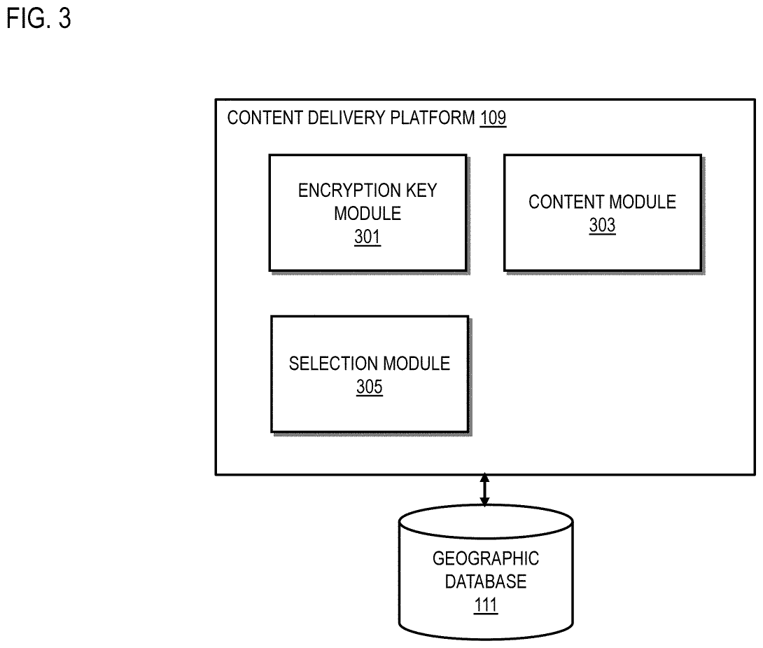

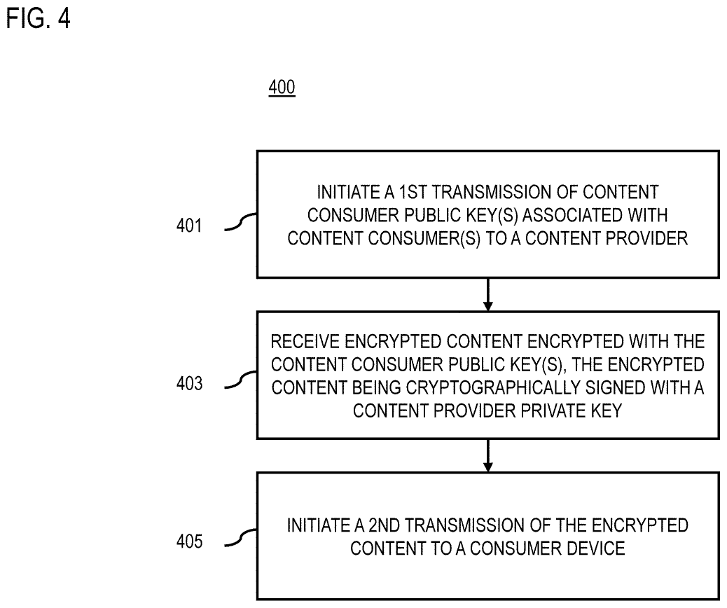

In one embodiment, the content delivery platform 109 includes one or more components for providing navigation and location recommendation based on geospatial vaccination data, according to the various embodiments described herein. As shown in FIG. 3, the content delivery platform 109 includes an encryption key module 301, a content module 303, a selection module 305, and an output module 307. The above presented modules and components of the content delivery platform 109 can be implemented in hardware, firmware, software, or a combination thereof. It is contemplated that the functions of these components may be combined or performed by other components of equivalent functionality. Though depicted as a separate entity in FIG. 1, it is contemplated that the content delivery platform 109 may be implemented as a module of any of the components of the system 100 (e.g., a component of the AD service 107a). In another embodiment, the content delivery platform 109 and/or one or more of the modules 301-305 may be implemented as a cloud-based service, local service, native application, or combination thereof. The functions of these modules are discussed with respect to FIGS. 4-7 below.

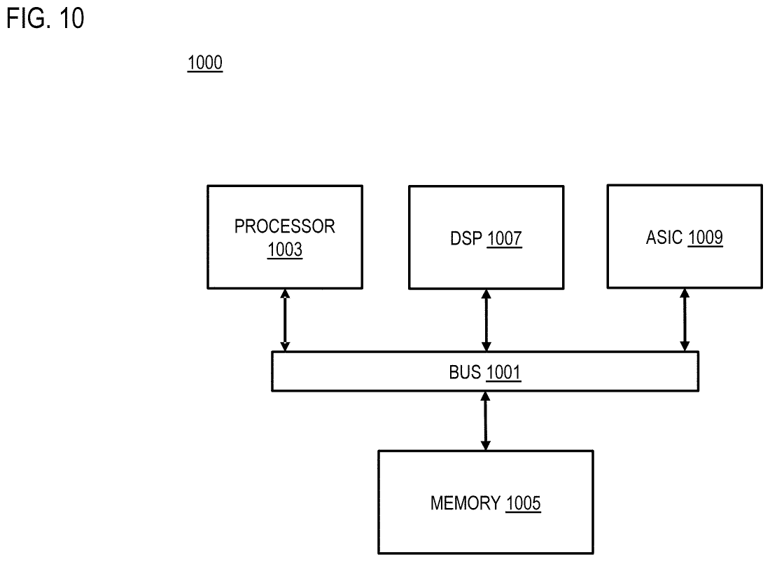

FIG. 4 is a flowchart of a process 400 for a content delivery platform to facilitate a privacy-preserving yet targeted delivery of location-based content, according to one embodiment. In various embodiments, the content delivery platform 109, any of the modules 301-305, and/or a content delivery application 117 residing in the UE 101 may perform one or more portions of the process 400 and may be implemented in, for instance, a chip set including a processor and a memory as shown in FIG. 10. As such, the content delivery platform 109, any of the modules 301-305, and/or the content delivery application 117 can provide means for accomplishing various parts of the process 400, as well as means for accomplishing embodiments of other processes described herein in conjunction with other components of the system 100. Although the process 400 is illustrated and described as a sequence of steps, its contemplated that various embodiments of the process 400 may be performed in any order or combination and need not include all of the illustrated steps. More specifically, the process 400 illustrates a process for facilitating a privacy-preserving yet targeted delivery of location-based content.

In one embodiment, for example in step 401, the encryption key module 301 can initiate a first transmission of at least one content consumer public key associated with at least one content consumer (e.g., carrying UE 101) to a content provider (e.g., the content provider 103). By way of example, the content provider can be a shop (or associated with the shop), and the encrypted content can relate to discount data, advertising data, or a combination thereof associated with the shop.

In one embodiment, in step 403, in response to the transmission, the content module 303 can receive encrypted content encrypted with the at least one content consumer public key. For instance, the encrypted content can be cryptographically signed with a content provider private key associated with the content provider 103.

In one embodiment, in step 405, the content module 303 can initiate a second transmission of the encrypted content to a consumer device (e.g., UE 101). By way of example, the second transmission of the encrypted content to the consumer device can be initiated based on location data associated with the scanning or the detecting. For instance, a content provider public key for decrypting the encrypted content is made available based on (1) the consumer device scanning the content provider public key at a location (e.g., the shop) designated by the content provider (e.g., the active mode), or (2) detecting that the consumer device is located within a threshold proximity of the location (e.g., the shop) designated by the content provider (e.g., the passive mode).

For instance, all discounts within an area of interest (e.g., one or more zip codes, a town, a city, a geofence, etc.) can be cached on the UE 101, and then the UE 101 can scan one or more content provider public key media 110 and decrypt the corresponding discounts any time a consumer enters a coarse location/geo-fence. In this instance, the UE 101 does not disclose its coarse location to the content delivery platform 109. As another instance, the content delivery platform 109 can transmit the content provider public key to the UE 101 based on detecting that the UE 101 is located within a threshold proximity of the store.

In this case, the location data can comprise a coarse location of the consumer device (e.g., within a radius of the cell tower that the UE 101 connected to), and the coarse location can be transformed spatially (e.g., 2D, 3D, etc.), temporally (with a rough time frame), or a combination thereof to a lower level of granularity than is detectable by a location sensor (e.g., a GPS receiver) of the consumer device (e.g., UE 101). As such, the content delivery platform 109 only knows the coarse location of the consumer device during a rough time frame, rather than a precise location of the consumer device at a specific time point, thereby enhancing the consumer data privacy.

In one embodiment, the encrypted content can be pre-cached and then decrypted by the consumer device (e.g., UE 101), presented in a user interface of the consumer device, or a combination thereof based on the scanning or the detecting (e.g., the passive mode).

In another embodiment, the encrypted content can be made available for scanning based on a scannable code (e.g., a QR code), a scannable tag (e.g., an NFC tag), a scannable beacon (e.g., a Bluetooth beacon), a short-range wireless signal (e.g., a Wi-Fi signal), or a combination thereof associated with the location (e.g., the shop) designated by the content provider (e.g., the active mode).

In one embodiment, the selection module 305 (or the AD service 107a) can select the at least one content consumer based on a computed relevance score between one or more characteristics (e.g., jobs, address, educations, hobbies, income, exercises, gym memberships, etc.) specified by the content provider 103 and profile data associated with the at least one content consumer. For example, the selection module 305 can select consumers with profiles of a relevance score of 100, i.e., 100% matching the target profile. As another example, the selection module 305 can select consumers with profiles of a relevance score of 90, i.e., 90% matching the target profile.

In one embodiment, the encrypted content can be decrypted by the consumer device (e.g., UE 101), and the decrypted content can be presented directly from the consumer device to the content provider (e.g., at the shop). For instance, content use data can be tracked by the content provider 103 based on the presenting of the decrypted content by the consumer device. In one embodiment, the encrypted content (e.g., an encrypted discount), decrypted content (e.g., the discount) that is decrypted from the encrypted data, or a combination thereof can be cached at the consumer device (e.g., UE 101).

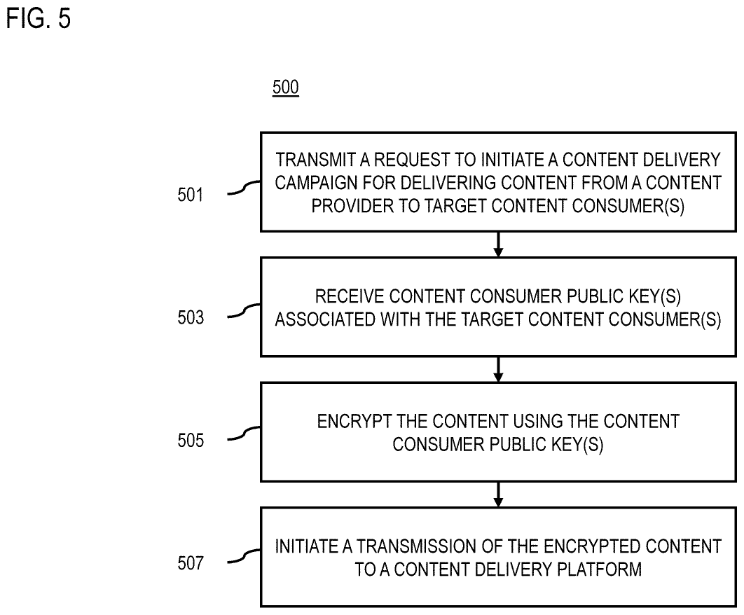

FIG. 5 is a flowchart of a process 500 for a content provider to facilitate a privacy-preserving yet targeted delivery of location-based content, according to one embodiment. In various embodiments, the content provider 103 may perform one or more portions of the process 500 and may be implemented in, for instance, a chip set including a processor and a memory as shown in FIG. 10. As such, the content provider 103 can provide means for accomplishing various parts of the process 500, as well as means for accomplishing embodiments of other processes described herein in conjunction with other components of the system 100. Although the process 500 is illustrated and described as a sequence of steps, its contemplated that various embodiments of the process 500 may be performed in any order or combination and need not include all of the illustrated steps. More specifically, the process 500 illustrates a process for facilitating a privacy-preserving yet targeted delivery of location-based content.

In one embodiment, for example in step 501, a processor and/or server associated with the content provider 103 can transmit a request to initiate a content delivery campaign for delivering content (e.g., 12 pm-2 pm half-price fresh roses at Store “A”) from the content provider 103 (e.g., Store “A”) to at least one content consumer (e.g., via UE 101). For instance, the request can specify a target profile (e.g., mothers aged 30+ with at least one hobby including tennis, gardening, or rock/mountain climbing) for selecting the at least one content consumer.

In one embodiment, in step 503, in response to the request, the processor and/or server associated with the content provider 103 can receive at least one content consumer public key associated with at least one content consumer that is selected based on the target profile (e.g., mothers aged 30+ with at least one hobby including tennis, gardening, or rock/mountain climbing).

As mentioned, a content consumer public key can be an individual content consumer public key or a group content consumer public key associated with the target profile. As opposed to individual public keys, a group content consumer public key (of all content consumers of the system 100, or a subgroup of the content consumers of the system 100) can be generated by the content delivery platform 109 (to encrypt the discounts) and communicated to all the content consumers of the system 100. The advantages include the shop will not receive the individual public keys of the targeted content customers (which might allow tracking the consumers), the content delivery platform 109 then can reveal only the number of targeted content customers (without individual content consumer public keys) for computing the conversion rate. The disadvantages include that any content consumers (including non-targeted content customers) in the geofence can access the discounts. However, this disadvantage can be mitigated by sending the discounts only to targeted content customers, although the targeted content customers might forward the discounts to non-targeted content customers. The system 100 can generate target profiles with assigned keys as requested by the content providers 103.

In one embodiment, in step 505, the processor and/or server associated with the content provider 103 can encrypt the content (e.g., 12 pm-2 pm half-price fresh roses at Store “A”) using the at least one content consumer public key.

In one embodiment, in step 507, the processor and/or server associated with the content provider 103 can initiate a transmission of the encrypted content to a content delivery platform (e.g., the content delivery platform 109). For instance, the content delivery platform 109 can transmit the encrypted content to at least one consumer device (e.g., UE 101) associated with the at least one content consumer, and the consumer device can decrypt the encrypted content using a content provider public key scanned at a location (e.g., 175 112th Street, New York City) designated by the content provider (e.g., Store “A”) or provided based on the consumer device being within a threshold proximity (e.g., a geo-fence) to the location. By way of example, the decrypted content can include discount data for redemption by the content provider 103.

In one embodiment, the processor and/or server associated with the content provider 103 can receive the decrypted content directly from the consumer device (e.g., UE 101 at the Store “A”) without relaying from the content delivery platform 109.

In one embodiment, the processor and/or server associated with the content provider 103 can verify the decrypted content (e.g., 12 pm-2 pm half-price fresh roses at Store “A”) using a content provider private key. Since the content provider cryptographically signed the content is with its content provider private key, the content provider 103 can verify the decrypted content matched the content that was cryptographically signed.

In one embodiment, the processor and/or server associated with the content provider 103 can register a use of the content (e.g., discount redemption) based on receiving the decrypted content from the consumer device (e.g., UE 101 at Store “A”).

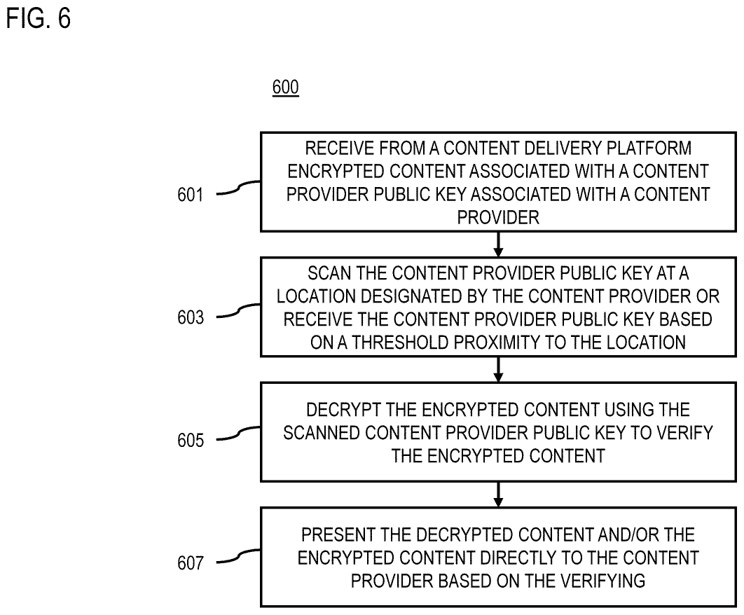

FIG. 6 is a flowchart of a process 600 for a user device to facilitate a privacy-preserving yet targeted delivery of location-based content, according to one embodiment. In various embodiments, the content delivery application 117 residing in the UE 101 may perform one or more portions of the process 600 and may be implemented in, for instance, a chip set including a processor and a memory as shown in FIG. 10. As such, the content delivery application 117 can provide means for accomplishing various parts of the process 600, as well as means for accomplishing embodiments of other processes described herein in conjunction with other components of the system 100. Although the process 600 is illustrated and described as a sequence of steps, its contemplated that various embodiments of the process 600 may be performed in any order or combination and need not include all of the illustrated steps. More specifically, the process 600 illustrates a process for facilitating a privacy-preserving yet targeted delivery of location-based content.

In one embodiment, for example in step 601, the content delivery application 117 (e.g., a custom and/or browser-based application installed at UE 101) can receive from a content delivery platform (e.g., the content delivery platform 109) encrypted content. For instance, the encrypted content can be associated with a content provider public key associated with a content provider 103. By way of example, the encrypted content can comprise discount data (e.g., 12 pm-2 pm half-price fresh roses at Store “A”), and the decrypted content, the encrypted content, or a combination thereof can be presented to the content provider 103 for redemption of the discount data.

In one embodiment, in step 603, the content delivery application 117 can scan the content provider public key provided at a location (e.g., 175 112th Street, New York City) designated by the content provider (e.g., Store “A”) or receiving the content provider public key based on a threshold proximity (e.g., a geo-fence) to the location. For instance, the content provider public key can be provided for scanning as a scannable code (e.g., a QR code), a scannable tag (e.g., an NFC tag), a scannable beacon (e.g., a Bluetooth beacon), a short-range wireless signal (e.g., a Wi-Fi signal), or a combination thereof fixed at the location designated by the content provider (e.g., the active mode).

In another embodiment, the content delivery application 117 can select the encrypted content based on determining that a consumer device (e.g., UE 101) is within a geo-fence (e.g., the passive mode). In yet another embodiment, the content delivery application 117 can select the encrypted content based on determining that a consumer device (e.g., UE 101) is within a pre-determined proximity (e.g., a geo-fence) of the location designated by the content provider (e.g., the passive mode).

In one embodiment, in step 605, the content delivery application 117 can decrypt the encrypted content using the scanned content provider public key to verify the encrypted content (e.g., 12 pm-2 pm half-price fresh roses at Store “A”).

In one embodiment, in step 607, the content delivery application 117 can present the decrypted content, the encrypted content, or a combination thereof directly to the content provider 103 based on the verifying.

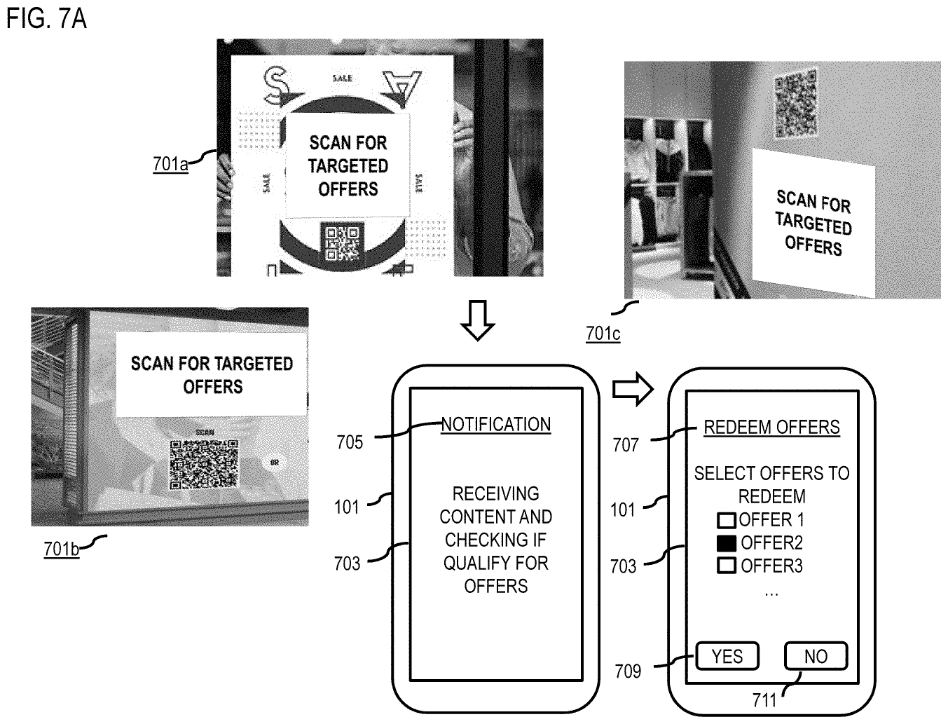

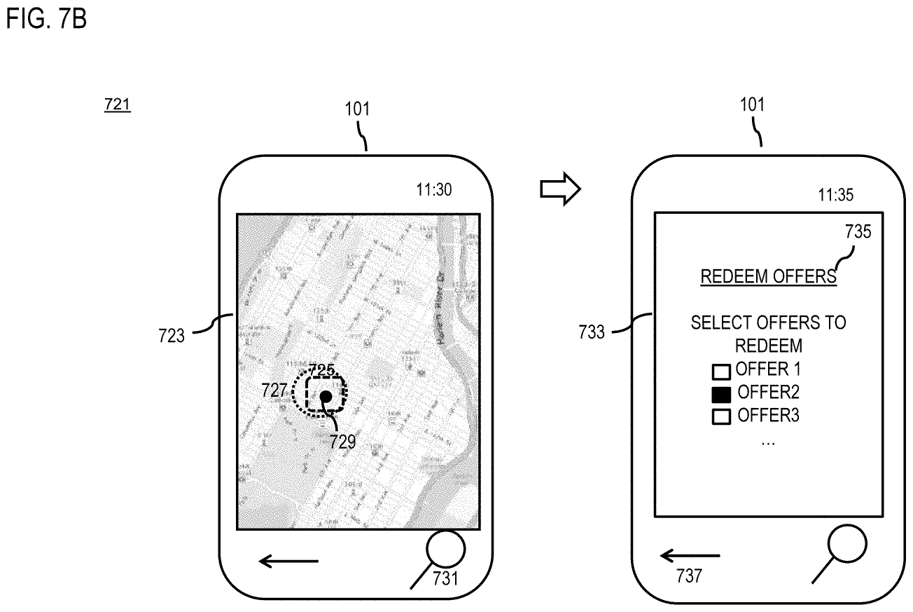

FIGS. 7A-7B are diagrams of example user interfaces depicting processes for providing a privacy-preserving yet targeted delivery of location-based content, according to various example embodiments. FIG. 7A depicts active mode scenarios 701a-701c in which UE 101 can scan one or more QR codes embodied the same content provider public key or different content provider public keys. In the scenario 701a, a QR code is presented with “Scan for targeted offers” on a poster on a class door of a store. In the scenario 701b, a QR code is presented with “Scan for targeted offers” on a digital signage in a mall. In the scenario 701c, a QR code is presented with “Scan for targeted offers” on a wall in a store.

In this example, after scanning a QR code to initiate a redemption process, a user interface (UI) 703 of the UE 101 can present a notification 705: “Receiving content and checking if qualify for offers.” Upon verifying that the UE 101 has stored therein one or more offers associated with a content provider public key that matches the scanned content provider public key, the UE 101 can decrypt the offer(s) using the user's private key, and make the UI 703 to display another notification 707: “Redeem offers: Select offers to redeem,” a “yes” button 709 and a “no” button 711 with respect to redemption. For instance, in response to user selections of the offer 2 and the “yes” button 709, the UE 101 can facilitate the user to redeem the offer 2 at the store. By way of example, the offer 2 can be available at Store “A” with a phone number 212.555.1234 and a website “www.Store_A.com” located at 175 112th Street, New York City: 12 pm-2 pm half-price fresh roses for mothers aged 30+ with at least one hobby including tennis, gardening, or rock/mountain climbing.

FIG. 7B depicts a passive mode scenario 721 in which the content deliver platform 109 can provides a list of relevant stores and their associated content provider public keys to the UE 101, based on a coarse location of the UE 101 and the store locations to be shown in a map UI 723. For instance, the coarse location of the UE 101 can be depicted as within a circle 725 from a base station connecting the UE 101 in the map UI 723. The coarse location of the UE 101 can be expressed in any shape or form, e.g., as covered by the connected base station. In this example, the content deliver platform 109 only knows the coarse location of the UE 101, but not the precise location of the UE 101.

The UE 101 can set a geo-fence 727 (e.g., a rectangular box or any other polygon shape) with respect to a current location 729 (e.g., GPS coordinates) of the UE 101, in response to a user section of a “Search” icon 731, thereby determining a list of store offers within the geo-fence 727. The UE 101 can then check the signatures of the list of store offers against the respective content provider public key(s), decrypt the offers using the user's private key, and make the UI 733 to display another notification 735: “Redeem offers: Select offers to redeem” and a list of offers for redemption. For instance, in response to user selections of the offer 2 and an “Enter” icon 737, the UE 101 can facilitate the user to navigate to a relevant store, to redeem the offer 2 at the store, etc.

Returning to FIG. 1, the services 107 may also be other third-party services and include traffic incident services, travel planning services, notification services, application services, storage services, contextual information determination services, etc.

In one embodiment, the content delivery platform 109 may be a platform with multiple interconnected components. The content delivery platform 109 may include multiple servers, intelligent networking devices, computing devices, components, and corresponding software for providing a privacy-preserving yet targeted delivery of location-based content. In addition, it is noted that the content delivery platform 109 may be a separate entity of the system 100, a part of the services platform 105, or a part of the one or more services 107.

In one embodiment, content providers 103 may provide content or data (e.g., including sensor data, road closure reports, probe data, expected vehicle volume data, etc.) to the content delivery platform 109, the UEs 101, the applications 117, the services platform 105, the services 107, and the geographic database 111. The content provided may be any type of content, such as map content, textual content, audio content, video content, image content, etc. In one embodiment, the content providers 103 may also store content associated with the content delivery platform 109, the services platform 105, the services 107, the geographic database 111, and/or the UEs 101. In another embodiment, the content providers 103 may manage access to a central repository of data, and offer a consistent, standard interface to data, such as a repository of the geographic database 111.

By way of example, the UEs 101 are any type of mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 101 can support any type of interface to the user (such as “wearable” circuitry, etc.). In one embodiment, a UE 101 may be associated with a vehicle 103 (e.g., a mobile device) or be a component part of the vehicle 103 (e.g., an embedded navigation system). In one embodiment, the UEs 101 may interact with the content providers 103 (e.g., a shop) and the content delivery platform 109 to provide a privacy-preserving yet targeted delivery of location-based content.

In one embodiment, the UEs 101 may also be configured with various sensors (not shown for illustrative convenience) for acquiring and/or generating sensor data and/or probe data associated with providing a privacy-preserving yet targeted delivery of location-based content. For example, such sensors may be used as GNSS receivers for interacting with the one or more satellites to determine and track the current speed, position, and location of UE 101. Further, the location can be determined by visual odometry, triangulation systems such as A-GPS, Cell of Origin, or other location extrapolation technologies.

In addition, the sensors may gather tilt data (e.g., a degree of incline or decline of the vehicle during travel), motion data, light data, sound data, image data, weather data, temporal data and other data associated with the UEs 101. Still further, the sensors may detect local or transient network and/or wireless signals, such as those transmitted by nearby devices during navigation of a vehicle along a roadway (Li-Fi, near field communication (NFC)) etc. Other examples of sensors 119 of the UE 101 may include light sensors, moisture sensors, pressure sensors, audio sensors (e.g., microphone), receivers for different short-range communications (e.g., Bluetooth, Wi-Fi, etc.), etc. In a further example embodiment, sensors 119 about the perimeter of UE 101 may detect the relative distance of the UE 101 from a physical object.

It is noted therefore that the above described data may be transmitted via the communication network 113 as sensor data (e.g., including 5G signal data) according to other known wireless communication protocols. For example, each UE 101 may be assigned a unique probe identifier (source ID) for use in reporting or transmitting the sensor data collected by the UEs 101.

In one embodiment, the communication network 113 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 5G/5G New Radio networks (5G NR), Narrowband Internet-of-Things networks (NB-IoT), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the content delivery platform 109, UEs 101, applications 117, services platform 105, services 107, and/or content providers 103 communicate with each other and other components of the system 100 using well known, new or still developing protocols. In this context, a protocol includes a set of rules defining how the network nodes within the communication network 113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

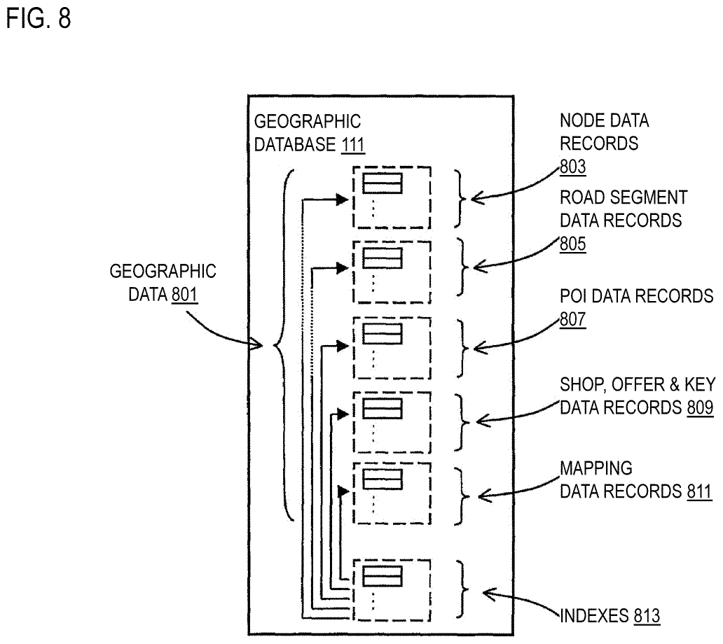

FIG. 8 is a diagram of a geographic database (such as the database 111), according to one embodiment. In one embodiment, the geographic database 111 includes geographic data 801 used for (or configured to be compiled to be used for) mapping and/or navigation-related services, such as for video odometry based on the parametric representation of lanes include, e.g., encoding and/or decoding parametric representations into lane lines. In one embodiment, the geographic database 111 include high resolution or high definition (HD) mapping data that provide centimeter-level or better accuracy of map features. For example, the geographic database 111 can be based on Light Detection and Ranging (LiDAR) or equivalent technology to collect billions of 3D points and model road surfaces and other map features down to the number lanes and their widths. In one embodiment, the mapping data (e.g., mapping data records 811) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 111.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 111 follows certain conventions. For example, links do not cross themselves and do not cross each other except at a node. Also, there are no duplicated shape points, nodes, or links. Two links that connect each other have a common node. In the geographic database 111, overlapping geographic features are represented by overlapping polygons. When polygons overlap, the boundary of one polygon crosses the boundary of the other polygon. In the geographic database 111, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 111 includes node data records 803, road segment or link data records 805, POI data records 807, shop, encrypted offer, and key data records 809, mapping data records 811, and indexes 813, for example. More, fewer or different data records can be provided. In one embodiment, additional data records (not shown) can include cartographic (“carto”) data records, routing data, and maneuver data. In one embodiment, the indexes 813 may improve the speed of data retrieval operations in the geographic database 111. In one embodiment, the indexes 813 may be used to quickly locate data without having to search every row in the geographic database 111 every time it is accessed. For example, in one embodiment, the indexes 813 can be a spatial index of the polygon points associated with stored feature polygons.

In exemplary embodiments, the road segment data records 805 are links or segments representing roads, streets, or paths, as can be used in the calculated route or recorded route information for determination of one or more personalized routes. The node data records 803 are end points (such as intersections) corresponding to the respective links or segments of the road segment data records 805. The road link data records 805 and the node data records 803 represent a road network, such as used by vehicles, cars, and/or other entities. Alternatively, the geographic database 111 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 111 can include data about the POIs and their respective locations in the POI data records 807. The geographic database 111 can also include data about places, such as cities, towns, or other communities, and other geographic features, such as bodies of water, mountain ranges, etc. Such place or feature data can be part of the POI data records 807 or can be associated with POIs or POI data records 807 (such as a data point used for displaying or representing a position of a city). In one embodiment, certain attributes, such as lane marking data records, mapping data records and/or other attributes can be features or layers associated with the link-node structure of the database.

In one embodiment, the geographic database 111 can also include the shop, encrypted offer, and key data records 809 for storing public key data of content providers and consumers, encrypted offer data, shop location data, prediction models, annotated observations, computed featured distributions, sampling probabilities, and/or any other data generated or used by the system 100 according to the various embodiments described herein. By way of example, the shop, encrypted offer, and key data records 809 can be associated with one or more of the node records 803, road segment records 805, and/or POI data records 807 to support localization or visual odometry based on the features stored therein and the corresponding estimated quality of the features. In this way, the records 809 can also be associated with or used to classify the characteristics or metadata of the corresponding records 803, 805, and/or 807.

In one embodiment, as discussed above, the mapping data records 811 model road surfaces and other map features to centimeter-level or better accuracy. The mapping data records 811 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 811 are divided into spatial partitions of varying sizes to provide mapping data to UEs 101, vehicles and other end user devices with near real-time speed without overloading the available resources of the vehicles and/or devices (e.g., computational, memory, bandwidth, etc. resources).

In one embodiment, the mapping data records 811 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 811.

In one embodiment, the mapping data records 811 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 111 can be maintained by the content provider 103 in association with the services platform 105 (e.g., a map developer). The map developer can collect geographic data to generate and enhance the geographic database 111. There can be different ways used by the map developer to collect data. These ways can include obtaining data from other sources, such as municipalities or respective geographic authorities. In addition, the map developer can employ field personnel to travel by vehicle (e.g., vehicles and/or user terminals 101) along roads throughout the geographic region to observe features and/or record information about them, for example. Also, remote sensing, such as aerial or satellite photography, can be used.

The geographic database 111 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle or a user terminal 101, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for providing a privacy-preserving yet targeted delivery of location-based content may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

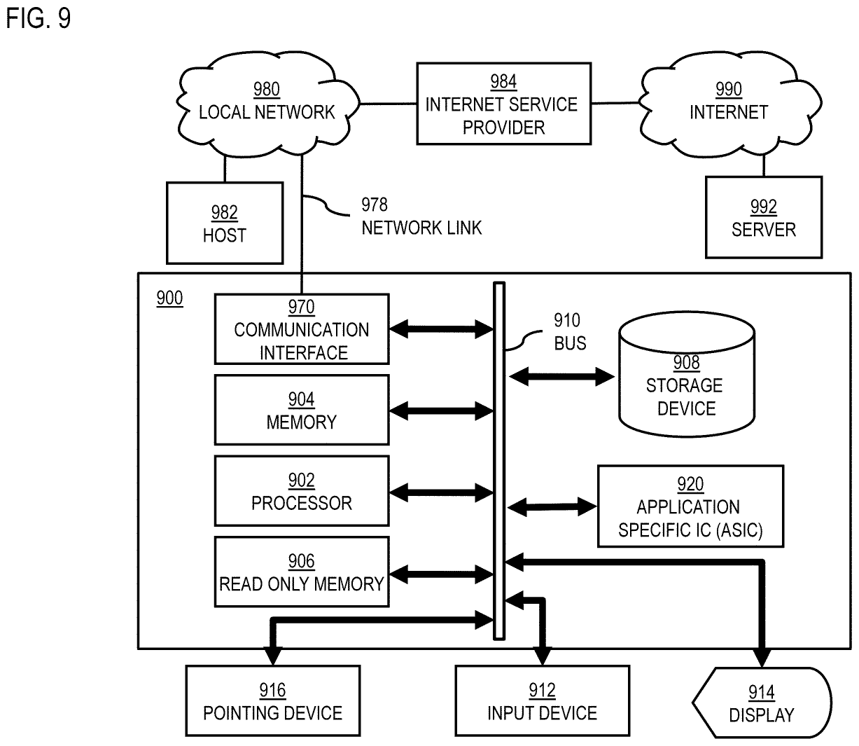

FIG. 9 illustrates a computer system 900 upon which an embodiment of the invention may be implemented. Computer system 900 is programmed (e.g., via computer program code or instructions) to provide a privacy-preserving yet targeted delivery of location-based content as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to providing a privacy-preserving yet targeted delivery of location-based content. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RANI) or other dynamic storage device, stores information including processor instructions for providing a privacy-preserving yet targeted delivery of location-based content. Dynamic memory allows information stored therein to be changed by the computer system 900. RANI allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing a privacy-preserving yet targeted delivery of location-based content, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 113 for providing a privacy-preserving yet targeted delivery of location-based content to the UE 101.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system can be deployed in various configurations within other computer systems, e.g., host 982 and server 992.

FIG. 10 illustrates a chip set 1000 upon which an embodiment of the invention may be implemented. Chip set 1000 is programmed to provide a privacy-preserving yet targeted delivery of location-based content as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide a privacy-preserving yet targeted delivery of location-based content. The memory 1005 also stores the data associated with or generated by the execution of the inventive steps.

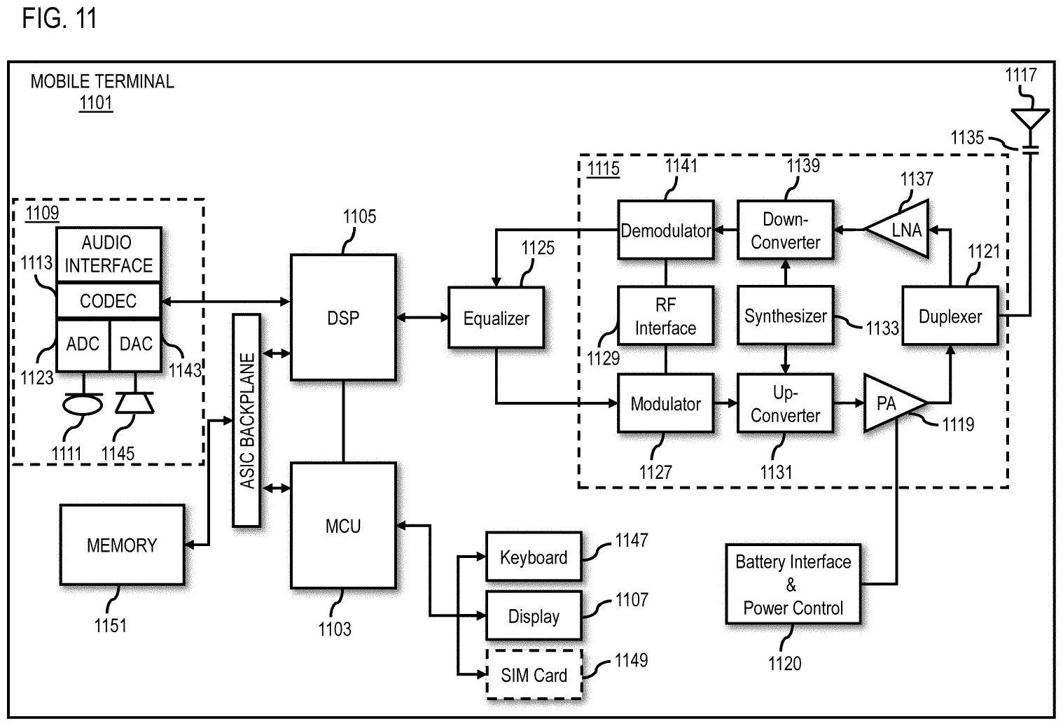

FIG. 11 is a diagram of exemplary components of a mobile terminal 1101 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions that offer automatic contact matching. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (Wi-Fi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile station 1101 to provide a privacy-preserving yet targeted delivery of location-based content. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1151 may be, but not limited to, a single memory, CD, DVD, ROM, RAM, EEPROM, optical storage, or any other non-volatile or non-transitory storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
initiating a first transmission of at least one content consumer public key associated with at least one content consumer to a content provider;
in response to the transmission, receiving encrypted content encrypted with the at least one content consumer public key, wherein the encrypted content is cryptographically signed with a content provider private key associated with the content provider; and
initiating a second transmission of the encrypted content to a consumer device,
wherein a content provider public key for decrypting the encrypted content is made available based on (1) the consumer device scanning the content provider public key at a location designated by the content provider, or (2) detecting that the consumer device is located within a threshold proximity of the location designated by the content provider.

2. The method of claim 1, wherein the content provider is a shop, and wherein the encrypted content relates to discount data, advertising data, or a combination thereof associated with the shop.

3. The method of claim 1, further comprising:
selecting the at least one content consumer based on a computed relevance score between one or more characteristics specified by the content provider and profile data associated with the at least one content consumer.

4. The method of claim 1, wherein the second transmission of the encrypted content to the consumer device is initiated based on location data associated with the scanning or the detecting.

5. The method of claim 4, wherein the location data comprises a coarse location of the consumer device, and wherein the coarse location is transformed spatially, temporally, or a combination thereof to a lower level of granularity than is detectable by a location sensor of the consumer device.

6. The method of claim 1, wherein the encrypted content is pre-cached and then decrypted by the consumer device, presented in a user interface of the consumer device, or a combination thereof based on the scanning or the detecting.

7. The method of claim 1, wherein the encrypted content is made available for scanning based on a scannable code, a scannable tag, a scannable beacon, a short-range wireless signal, or a combination thereof associated with the location designated by the content provider.

8. The method of claim 1, wherein the encrypted content is decrypted by the consumer device, and wherein the decrypted content is presented directly from the consumer device to the content provider.

9. The method of claim 8, wherein content use data is tracked by the content provider based on the presenting of the decrypted content by the consumer device.

10. An apparatus comprising:
at least one processor; and
at least one memory including computer program code for one or more programs,
the at least one memory and the computer program code configured to, with the at least one processor, cause the apparatus to perform at least the following,
transmit a request to initiate a content delivery campaign for delivering content from a content provider to at least one content consumer, wherein the request specifies a target profile for selecting the at least one content consumer;
in response to the request, receive at least one content consumer public key associated with at least one content consumer that is selected based on the target profile;
encrypt the content using the at least one content consumer public key; and
initiate a transmission of the encrypted content to a content delivery platform,
wherein the content delivery platform transmits the encrypted content to at least one consumer device associated with the at least one content consumer, and
wherein the consumer device decrypts the encrypted content using a content provider public key scanned at a location designated by the content provider or provided based on the consumer device being within a threshold proximity to the location.

11. The apparatus of claim 10, wherein the content consumer public key is one of an individual content consumer public key or a group content consumer public key.

12. The apparatus of claim 10, wherein the apparatus is further caused to:
receive the decrypted content directly from the consumer device without relaying from the content delivery platform.

13. The apparatus of claim 10, wherein the decrypted content includes discount data for redemption by the content provider.

14. The apparatus of claim 10, wherein the apparatus is further caused to:
verify the decrypted content using a content provider private key.

15. The apparatus of claim 10, wherein the apparatus is further caused to:
register a use of the content based on receiving the decrypted content from the consumer device.

16. A non-transitory computer-readable storage medium, carrying one or more sequences of one or more instructions which, when executed by one or more processors, cause an apparatus to at least perform the following steps:
receiving from a content delivery platform encrypted content, wherein the encrypted content is associated with a content provider public key associated with a content provider;
scanning the content provider public key provided at a location designated by the content provider or receiving the content provider public key based on a threshold proximity to the location;
decrypting the encrypted content using the scanned content provider public key to verify the encrypted content; and
presenting the decrypted content, the encrypted content, or a combination thereof directly to the content provider based on the verifying.

17. The non-transitory computer-readable storage medium of claim 16, wherein the apparatus is caused to further perform:
selecting the encrypted content based on determining that a consumer device is within a geo-fence.

18. The non-transitory computer-readable storage medium of claim 16, wherein the apparatus is caused to further perform:
selecting the encrypted content based on determining that a consumer device is within a pre-determined proximity of the location designated by the content provider.

19. The non-transitory computer-readable storage medium of claim 16, wherein the encrypted content comprises discount data, and wherein the decrypted content, the encrypted content, or a combination thereof is presented to the content provider for redemption of the discount data.

20. The non-transitory computer-readable storage medium of claim 16, wherein the content provider public key is provided for scanning as a scannable code, a scannable tag, a scannable beacon, a short-range wireless signal, or a combination thereof fixed at the location designated by the content provider.
